(19) United States
(12) Patent Application Publication
(10) Pub. No.: US 2019/0215706 A1
(43) Pub. Date: Jul. 11, 2019

(54) METHOD AND APPARATUS OF BEAM FAILURE RECOVERY VIA RANDOM ACCESS PROCEDURE IN A WIRELESS COMMUNICATION SYSTEM

(71) Applicant: ASUSTek Computer Inc., Taipei City 112 (TW)

(72) Inventor: Hsin-Hsi Tsai, Taipei City (TW)

(21) Appl. No.: 16/010,210

(22) Filed: Jun. 15, 2018

Related U.S. Application Data
(60) Provisional application No. 62/616,142, filed on Jan. 11, 2018.

(51) Int. Cl. H04W 24/04; H04W 74/08; H04W 72/04

(52) U.S. Cl. CPC H04W 24/04; H04W 72/046; H04W 72/042; H04W 74/0833

(57) ABSTRACT

Methods and apparatuses of beam failure recovery via random access procedure in a wireless communication system are disclosed herein. In one method, a user equipment (UE) initiates a beam failure recovery procedure when beam failure is detected based on a beam failure indication. The UE initiates a random access procedure, wherein the random access procedure is a contention-based random access procedure and initiated based on the beam failure indication. The UE considers the beam failure recovery procedure successfully completed based on completion of the random access procedure.

### CROSS-REFERENCE TO RELATED APPLICATIONS

The present application claims the benefit of U.S. Provisional Patent Application Ser. No. 62/616,142 filed on Jan. 11, 2018, the entire disclosure of which is incorporated herein in its entirety by reference.

### FIELD

This disclosure generally relates to wireless communication networks, and more particularly, to a method and apparatus of beam failure recovery via random access procedure in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods and apparatuses for random access procedures of beam failure recovery via random access procedure in a wireless communication system are disclosed herein. In one method, a user equipment (UE) initiates a beam failure recovery procedure when beam failure is detected based on a beam failure indication. The UE initiates a random access procedure, wherein the random access procedure is a contention-based random access procedure and initiated based on the beam failure indication. The UE considers the beam failure recovery procedure successfully completed based on completion of the random access procedure.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 illustrates a contention based and a contention free random access procedures as shown in 3GPP TS 38.300 v15.0.0.

FIG. 6 illustrates a E/T/R/R/BI MAC subheader as shown in 3GPP TS 38.321 v15.0.0.

FIG. 7 illustrates a E/T/RAPID MAC subheader as shown in 3GPP TS 38.321 v15.0.0.

FIG. 8 illustrates an example of MAC PDU consisting of MAC RARs as shown in 3GPP TS 38.321 v15.0.0.

FIG. 9 illustrates a MAC RAR as shown in 3GPP TS 38.321 v15.0.0.

FIG. 10 illustrates an example of a beam failure recovery via random access procedure.

FIG. 11 is a flow diagram for one exemplary embodiment from the perspective of a UE.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including: TS 38.300 v15.0.0, NR; NR and NG-RAN Overall Description; Stage 2 (Release 15); TS 38.321 v15.0.0, NR; Medium Access Control (MAC) protocol specification (Release 15); TS 38.331 v15.0.0; NR; Radio Resource Control (RRC) Protocol specification (Release 15); and TS 38.213 v15.0.0; NR; Physical layer procedures for control (Release 15). The standards and documents listed above are hereby expressly incorporated by reference in their entirety.

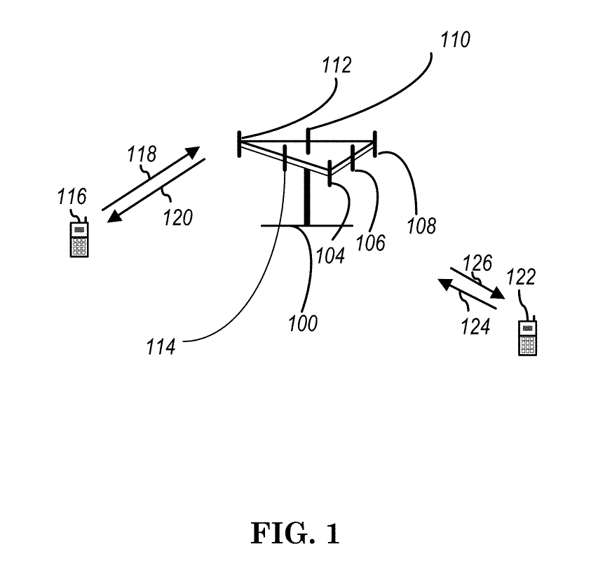

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

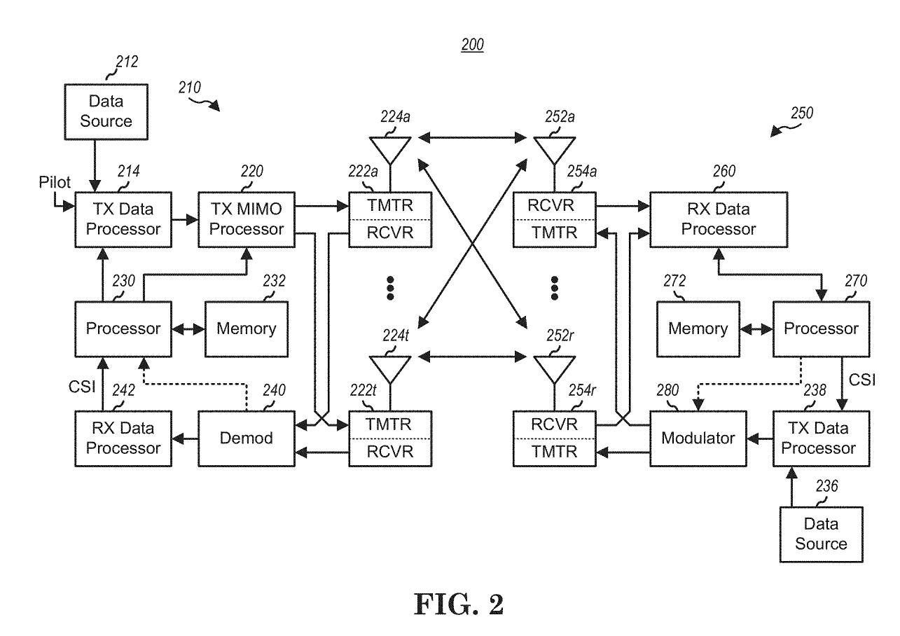

FIG. 2 is a simplified block diagram of an embodiment of a transmitter system 210 (also known as the access network) and a receiver system 250 (also known as access terminal (AT) or user equipment (UE) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

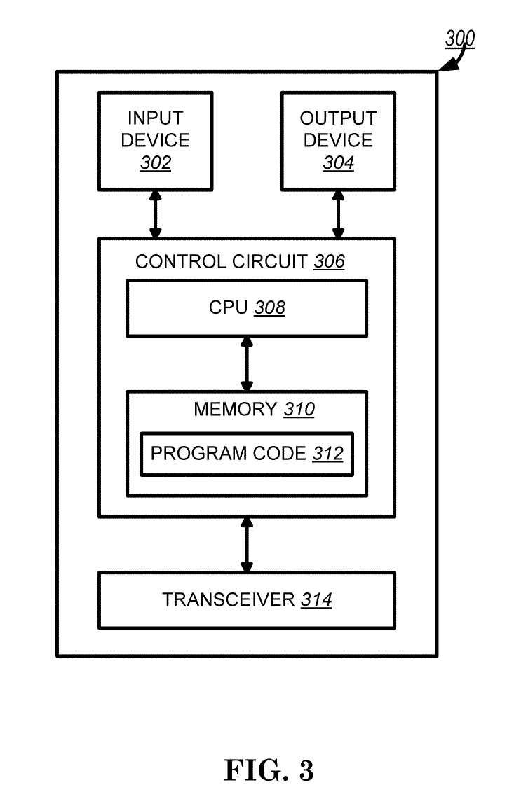

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

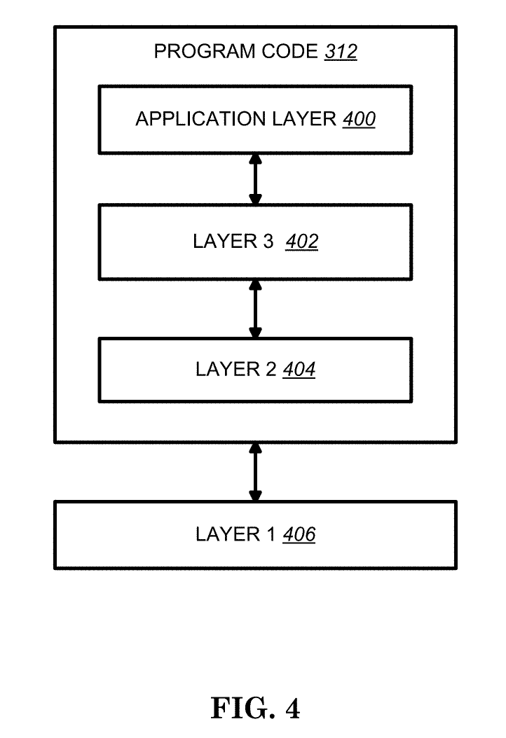

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP TS 38.300 v15.0.0 introduces random access procedure as quoted below:

### 5.3.4 Random Access

Random access preamble sequences, of two different lengths are supported. Long sequence length 839 is applied with subcarrier spacings of 1.25 and 5 kHz and short sequence length 139 is applied with sub-carrier spacings 15, 30, 60 and 120 kHz. Long sequences support unrestricted sets and restricted sets of Type A and Type B, while short sequences support unrestricted sets only.
Multiple RACH preamble formats are defined with one or more RACH OFDM symbols, and different cyclic prefix and guard time. The PRACH preamble configuration to use is provided to the UE in the system information.
The UE calculates the PRACH transmit power for the retransmission of the preamble based on the most recent estimate pathloss and power ramping counter. If the UE conducts beam switching, the counter of power ramping remains unchanged.
The system information informs the UE of the association between the SS blocks and the RACH resources. The threshold of the SS block for RACH resource association is based on the RSRP and network configurable.

### 9.2.6 Random Access Procedure

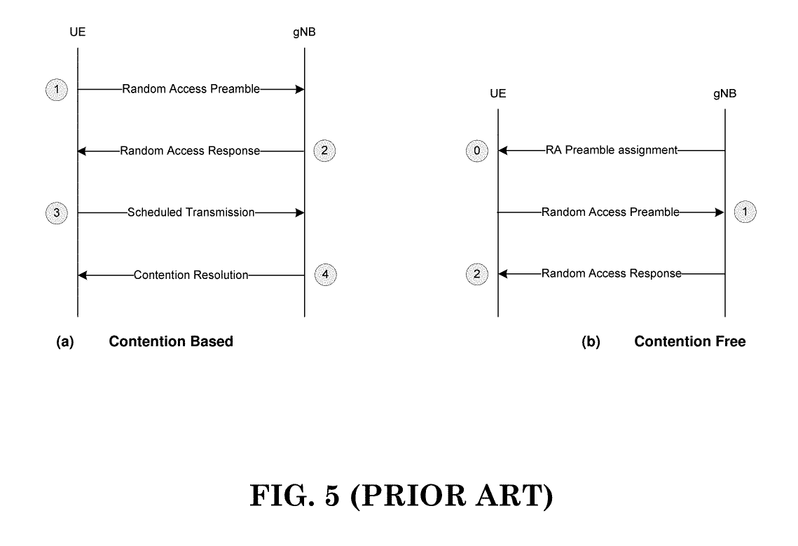

The random access procedure is triggered by a number of events, for instance:
Initial access from RRC_IDLE;
RRC Connection Re-establishment procedure;
Handover;
DL or UL data arrival during RRC_CONNECTED when UL synchronisation status is “non-synchronised”;
Transition from RRC_INACTIVE;
Request for Other SI (see subclause 7.3).
   Furthermore, the random access procedure takes two distinct forms: contention based and non-contention based as shown on (FIG. 5 which is a reproduction of Figure 9.2.6-1 taken from 3GPP 3GPP TS 38.300 v15.0.0) below. Normal DL/UL transmission can take place after the random access procedure.
   For initial access in a cell configured with SUL, the UE selects the SUL carrier if and only if the measured quality of the DL is lower than a broadcast threshold. Once started, all uplink transmissions of the random access procedure remain on the selected carrier.

3GPP TS 38.321 v15.0.0 introduces random access procedure as quoted below:

### 5.1 Random Access Procedure

### 5.1.1 Random Access Procedure Initialization

The Random Access procedure described in this subclause is initiated by a PDCCH order, by the MAC entity itself, by beam failure indication from lower layer, or by RRC for the events in accordance with TS 38.300 [2]. There is only one Random Access procedure ongoing at any point in time in a MAC entity. The Random Access procedure on an SCell other than PSCell shall only be initiated by a PDCCH order with ra-PreambleIndex different from 0b000000.
NOTE 1: If the MAC entity receives a request for a new Random Access procedure while another is already ongoing in the MAC entity, it is up to UE implementation whether to continue with the ongoing procedure or start with the new procedure (e.g. for SI request).
   RRC configures the following parameters for the Random Access procedure:
prach-ConfigIndex: the available set of PRACH resources for the transmission of the Random Access Preamble;
ra-PreambleInitialReceivedTargetPower: initial preamble power;
rsrp-ThresholdSSB, csirs-dedicatedRACH-Threshold, and sul-RSRP-Threshold: an RSRP threshold for the selection of the SS block and corresponding PRACH resource;
ra-PreamblePowerRampingStep: the power-ramping factor;
ra-PreambleIndex: Random Access Preamble;
ra-PreambleTx-Max: the maximum number of preamble transmission;
if SSBs are mapped to preambles:
   startIndexRA-PreambleGroupA, numberOfRA-Preambles, and numberOfRA-PreamblesGroupA for each SSB in each group (SpCell only).
else:
   startIndexRA-PreambleGroupA, numberOfRA-Preambles, and numberOfRA-PreamblesGroupA in each group (SpCell only).
If numberOfRA-PreamblesGroupA is equal to numberOfRA-Preambles, there is no Random Access Preambles group B.
   The preambles in Random Access Preamble group A are the preambles startIndexRA-PreambleGroupA to startIndexRA-PreambleGroupA+numberOfRA-PreamblesGroupA−1;
   The preambles in Random Access Preamble group B, if exists, are the preambles startIndexRA-PreambleGroupA+numberOfRA-PreamblesGroupA to startIndexRA-PreambleGroupA+numberOfRA-Preambles−1.
NOTE 2: if random Access Preambles group B is supported by the cell and SSBs are mapped to preambles, random access preambles group B is included in each SSB.
   if Random Access Preambles group B exists:
      ra-Msg3SizeGroupA (per cell): the threshold to determine the groups of Random Access Preambles.
   the set of Random Access Preambles for SI request and corresponding PRACH resource(s), if any;
   the set of Random Access Preambles for beam failure recovery request and corresponding PRACH resource(s), if any;
   ra-Response Window: the time window to monitor RA response(s);
   bfr-ResponseWindow: the time window to monitor response(s) on beam failure recovery request;
   ra-ContentionResolutionTimer: the Contention Resolution Timer (SpCell only).
      In addition, the following information for related Serving Cell is assumed to be available for UEs:
if Random Access Preambles group B exists:
   if the MAC Entity is configured with supplementary Uplink, and SUL carrier is selected for performing Random Access Procedure:
      P_{CMAX,c}_{_}_{SUL}: the configured UE transmitted power of the SUL carrier.
   else:
      P_{CMAX,c}: the configured UE transmitted power of the Serving Cell performing the Random Access Procedure.
         The following UE variables are used for the Random Access procedure:
PREAMBLE_INDEX;
PREAMBLE_TRANSMISSION_COUNTER;
PREAMBLE_POWER_RAMPING_COUNTER;
PREAMBLE_RECEIVED_TARGET_POWER;
PREAMBLE_BACKOFF;
PCMAX;
TEMPORARY_C-RNTI.
   When the Random Access procedure is initiated, the MAC entity shall:
1> flush the Msg3 buffer;
1> set the PREAMBLE_TRANSMISSION_COUNTER to 1;
1> set the PREAMBLE_POWER_RAMPING_COUNTER to 1;
1> set the PREAMBLE_BACKOFF to 0 ms;
1> if the carrier to use for the Random Access procedure is explicitly signalled:
   2> select the signalled carrier for performing Random Access procedure.
1> else if the carrier to use for the Random Access procedure is not explicitly signalled; and
1> if the cell for the Random Access procedure is configured with supplementaryUplink; and
1> if the RSRP of the downlink pathloss reference is less than sul-RSRP-Threshold:
   2> select the SUL carrier for performing Random Access procedure;
   2> set the PCMAX to P_{CMAX,c}_{_}_{SUL}.
1> else:
   2> select the normal carrier for performing Random Access procedure;
   2> set the PCMAX to P_{CMAX,c}.
1> perform the Random Access Resource selection procedure (see subclause 5.1.2).

### 5.1.2 Random Access Resource Selection

The MAC entity shall:
1> if the Random Access procedure was initiated by a beam failure indication from lower layer; and
1> if the contention free PRACH resources for beam failure recovery request associated with any of the SS blocks and/or CSI-RSs have been explicitly provided by RRC; and
1> if at least one of the SS blocks with SS-RSRP above rsrp-ThresholdSSB amongst the associated SS blocks or the CSI-RSs with CSI-RSRP above csirs-dedicatedRACH-Threshold amongst the associated CSI-RSs is available:
   2> select an SS block with SS-RSRP above rsrp-ThresholdSSB amongst the associated SS blocks or a CSI-RS with CSI-RSRP above csirs-dedicatedRACH-Threshold amongst the associated CSI-RSs;
   2> set the PREAMBLE_INDEX to a ra-PreambleIndex corresponding to the selected SS block or CSI-RS from the set of Random Access Preambles for beam failure recovery request.
1> else if the ra-PreambleIndex has been explicitly provided by either PDCCH or RRC; and
1> if the ra-PreambleIndex is not 0b000000; and
1> if contention free PRACH resource associated with SS blocks or CSI-RS have not been explicitly provided by RRC:
   2> set the PREAMBLE_INDEX to the signalled ra-PreambleIndex.
1> else if the contention free PRACH resources associated with SS blocks have been explicitly provided by RRC and at least one SS block with SS-RSRP above rsrp-ThresholdSSB amongst the associated SS blocks is available:
   2> select an SS block with SS-RSRP above rsrp-ThresholdSSB amongst the associated SS blocks;
   2> set the PREAMBLE_INDEX to a ra-PreambleIndex corresponding to the selected SS block.
1> else if the contention free PRACH resources associated with CSI-RSs have been explicitly provided by RRC and at least one CSI-RS with CSI-RSRP above csirs-dedicatedRACH-Threshold amongst the associated CSI-RSs is available:
   2> select a CSI-RS with CSI-RSRP above csirs-dedicatedRACH-Threshold amongst the associated CSI-RSs;
   2> set the PREAMBLE_INDEX to a ra-PreambleIndex corresponding to the selected CSI-RS.
1> else:
   2> select a SS block with SS-RSRP above rsrp-ThresholdSSB;
   2> if Msg3 has not yet been transmitted:
      3> if Random Access Preambles group B exists; and
      3> if the potential Msg3 size (UL data available for transmission plus MAC header and, where required, MAC CEs) is greater than ra-Msg3SizeGroupA and the pathloss is less than PCMAX (of the Serving Cell performing the Random Access Procedure)−ra-PreambleInitialReceivedTargetPower:
         4> select the Random Access Preambles group B.
      3> else:
         4> select the Random Access Preambles group A.
   2> else (i.e. Msg3 is being retransmitted):
      3> select the same group of Random Access Preambles as was used for the preamble transmission attempt corresponding to the first transmission of Msg3.
   2> if the association between Random Access Preambles and SS blocks is configured:
      3> select a ra-PreambleIndex randomly with equal probability from the random access preambles associated with the selected SS block and the selected group.
   2> else:
      3> select a ra-PreambleIndex randomly with equal probability from the random access preambles within the selected group.
   2> set the PREAMBLE_INDEX to the selected ra-PreambleIndex.
1> if an SS block is selected above and an association between PRACH occasions and SS blocks is configured:
   2> determine the next available PRACH occasion from the PRACH occasions corresponding to the selected SS block.
1> else if a CSI-RS is selected above and an association between PRACH occasions and CSI-RSs is configured:
   2> determine the next available PRACH occasion from the PRACH occasions corresponding to the selected CSI-RS.
1> else:
   2> determine the next available PRACH occasion.
1> perform the Random Access Preamble transmission procedure (see subclause 5.1.3).

### 5.1.3 Random Access Preamble Transmission

The MAC entity shall, for each preamble:
1> if PREAMBLE_TRANSMISSION_COUNTER is greater than one; and
1> if the notification of suspending power ramping counter has not been received from lower layers; and
1> if SS block selected is not changed (i.e. same as the previous random access preamble transmission):
   2> increment PREAMBLE_POWER_RAMPING_COUNTER by 1.
1> set PREAMBLE_RECEIVED_TARGET_POWER to ra-PreambleInitialReceivedTargetPower+DELTA_PREAMBLE+(PREAMBLE_POWER_RAMPING_COUNTER−1)*powerRampingStep;
1> except for contention free preamble for beam failure recovery request, compute the RA-RNTI associated with the PRACH in which the Random Access Preamble is transmitted;
1> instruct the physical layer to transmit the preamble using the selected PRACH, corresponding RA-RNTI (if available), PREAMBLE_INDEX and PREAMBLE_RECEIVED_TARGET_POWER.
   The RA-RNTI associated with the PRACH in which the Random Access Preamble is transmitted, is computed as:

RA-RNTI=1+s_id+14*t_id+14*X*f_id+14*X*Y*ul_carrier_id

where s_id is the index of the first OFDM symbol of the specified PRACH (0≤s_id<14), t_id is the index of the first slot of the specified PRACH in a system frame (0≤t_id<X), f_id is the index of the specified PRACH in the frequency domain (0≤f_id<Y), and ul_carrier_id is the UL carrier used for Msg1 transmission (0 for normal carrier, and 1 for SUL carrier). The values X and Y are specified in TS 38.213 [6].

### 5.1.4 Random Access Response Reception

Once the Random Access Preamble is transmitted and regardless of the possible occurrence of a measurement gap, the MAC entity shall:
1> if ‘multiple preamble transmission’ has been signalled:
   2> start the ra-Response Window at the start of the first PDCCH occasion after a fixed duration of X symbols (specified in TS 38.213 [6]) from the end of the first preamble transmission;
   2> monitor the PDCCH of the SpCell for Random Access Response(s) identified by the RA-RNTI(s) while ra-Response Window is running.
1> else if the contention free Random Access Preamble for beam failure recovery request was transmitted by the MAC entity:
   2> start the bfr-Response Window at the start of the first PDCCH occasion after a fixed duration of X symbols (specified in TS 38.213 [6]) from the end of the preamble transmission;
   2> monitor the PDCCH of the SpCell for response to beam failure recovery request identified by the C-RNTI while bfr-Response Window is running.
1> else:
   2> start the ra-Response Window at the start of the first PDCCH occasion after a fixed duration of X symbols (specified in TS 38.213 [6]) from the end of the preamble transmission;
   2> monitor the PDCCH of the SpCell for Random Access Response(s) identified by the RA-RNTI while the ra-Response Window is running.
1> if PDCCH transmission is addressed to the C-RNTI; and
1> if the contention free Random Access Preamble for beam failure recovery request was transmitted by the MAC entity:
   2> consider the Random Access procedure successfully completed.
1> else if a downlink assignment has been received on the PDCCH for the RA-RNTI and the received TB is successfully decoded:
   2> if the Random Access Response contains a Backoff Indicator subheader:
      3> set the PREAMBLE_BACKOFF to value of the BI field of the Backoff Indicator subheader using Table 7.2-1.
   2> else:
      3> set the PREAMBLE_BACKOFF to 0 ms.
   2> if the Random Access Response contains a Random Access Preamble identifier corresponding to the transmitted PREAMBLE_INDEX (see subclause 5.1.3):
      3> consider this Random Access Response reception successful.
   2> if the Random Access Response reception is considered successful:
      3> if the Random Access Response includes RAPID only:
         4> consider this Random Access procedure successfully completed;
         4> indicate the reception of an acknowledgement for the SI request to upper layers.
      3> else:
         4> if ‘multiple preamble transmission’ has been signalled:
         5> stop transmitting remaining preambles, if any.
         4> apply the following actions for the Serving Cell where the Random Access Preamble was transmitted:
         5> process the received Timing Advance Command (see subclause 5.2);
         5> indicate the ra-PreambleInitialReceivedTargetPower and the amount of power ramping applied to the latest preamble transmission to lower layers (i.e. (PREAMBLE_POWER_RAMPING_COUNTER−1)*powerRampingStep);
         5> process the received UL grant value and indicate it to the lower layers.
         4> if the Random Access Preamble was not selected by the MAC entity among the common PRACH preambles:
         5> consider the Random Access procedure successfully completed. 4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> obtain the MAC PDU to transmit from the Multiplexing and assembly entity and store it in the Msg3 buffer.
1> if ra-ResponseWindow expires, and if the Random Access Response containing Random Access Preamble identifiers that matches the transmitted PREAMBLE_INDEX has not been received; or
1> if bfr-ResponseWindow expires and if the PDCCH addressed to the C-RNTI has not been received:
   2> consider the Random Access Response reception not successful;
   2> increment PREAMBLE_TRANSMISSION_COUNTER by 1;
   2> if PREAMBLE_TRANSMISSION_COUNTER=ra-PreambleTx-Max+1:
      3> if the Random Access Preamble is transmitted on the SpCell:
         4> indicate a Random Access problem to upper layers.
      3> else if the Random Access Preamble is transmitted on a SCell:
         4> consider the Random Access procedure unsuccessfully completed.
   2> if in this Random Access procedure, the Random Access Preamble was selected by MAC among the common PRACH preambles:
      3> select a random backoff time according to a uniform distribution between 0 and the PREAMBLE_BACKOFF;
      3> delay the subsequent Random Access Preamble transmission by the backoff time.
   2> perform the Random Access Resource selection procedure (see subclause 5.1.2).
      The MAC entity may stop ra-ResponseWindow (and hence monitoring for Random Access Response(s)) after successful reception of a Random Access Response containing Random Access Preamble identifiers that matches the transmitted PREAMBLE_INDEX.
      HARQ operation is not applicable to the Random Access Response transmission.

### 5.1.5 Contention Resolution

Contention Resolution is based on either C-RNTI on PDCCH of the SpCell or UE Contention Resolution Identity on DL-SCH.
Once Msg3 is transmitted, the MAC entity shall:
1> start the ra-ContentionResolutionTimer and restart the ra-ContentionResolutionTimer at each HARQ retransmission;
1> monitor the PDCCH while the ra-ContentionResolutionTimer is running regardless of the possible occurrence of a measurement gap;
1> if notification of a reception of a PDCCH transmission is received from lower layers:
   2> if the C-RNTI MAC CE was included in Msg3:
      3> if the Random Access procedure was initiated by the MAC sublayer itself or by the RRC sublayer and the PDCCH transmission is addressed to the C-RNTI and contains an UL grant for a new transmission; or
      3> if the Random Access procedure was initiated by a PDCCH order and the PDCCH transmission is addressed to the C-RNTI:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> set the C-RNTI to the value of the TEMPORARY_C-RNTI;
         5> discard the TEMPORARY_C-RNTI;
         5> consider this Random Access procedure successfully completed.
         4> else
         5> discard the TEMPORARY_C-RNTI;
         5> consider this Contention Resolution not successful and discard the successfully decoded MAC PDU.
1> if ra-ContentionResolutionTimer expires:
   2> discard the TEMPORARY_C-RNTI;
   2> consider the Contention Resolution not successful.
1> if the Contention Resolution is considered not successful:
   2> flush the HARQ buffer used for transmission of the MAC PDU in the Msg3 buffer;
   2> increment PREAMBLE_TRANSMISSION_COUNTER by 1;
   2> if PREAMBLE_TRANSMISSION_COUNTER=preambleTransMax+1:
      3> indicate a Random Access problem to upper layers.
   2> select a random backoff time according to a uniform distribution between 0 and the PREAMBLE_BACKOFF;
   2> delay the subsequent Random Access Preamble transmission by the backoff time;
   2> perform the Random Access Resource selection procedure (see subclause 5.1.2).

### 5.1.6 Completion of the Random Access Procedure

Upon completion of the Random Access procedure, the MAC entity shall:
1> discard explicitly signalled ra-PreambleIndex, if any;
1> flush the HARQ buffer used for transmission of the MAC PDU in the Msg3 buffer.

### 6.1.5 MAC PDU (Random Access Response)

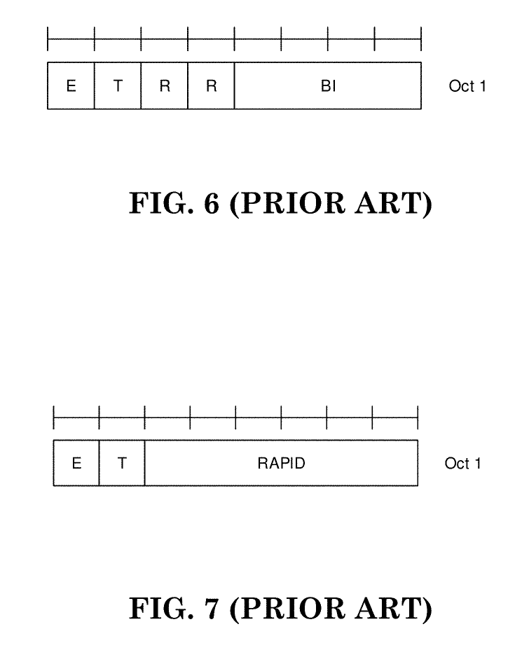

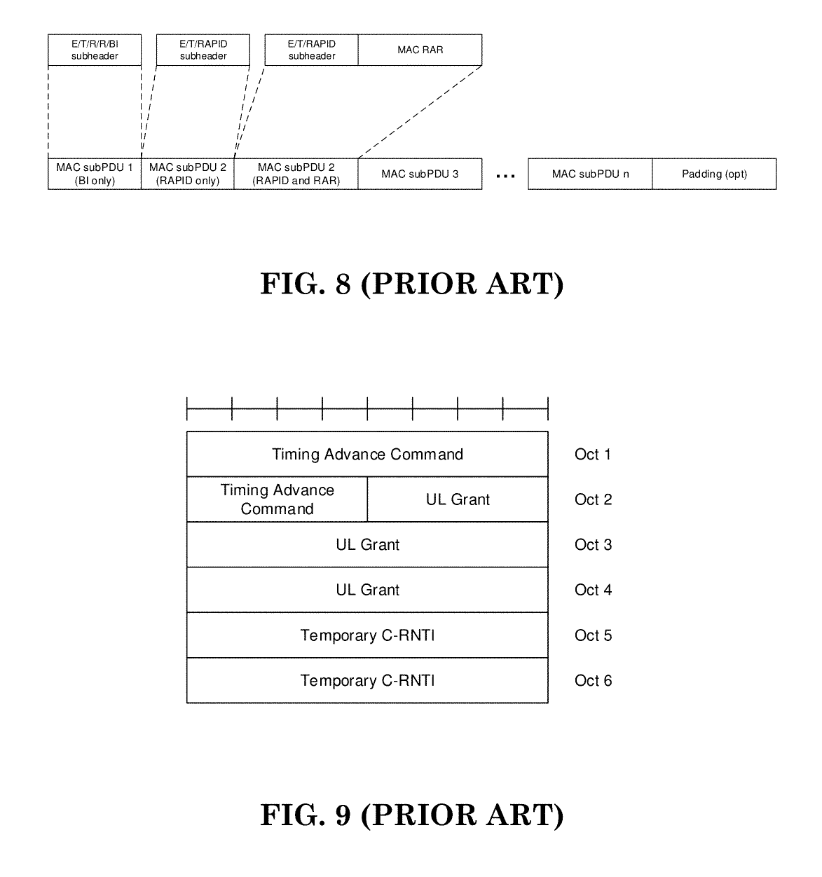

A MAC PDU consists of one or more MAC subPDUs and optionally padding. Each MAC subPDU consists one of the following:
a MAC subheader with Backoff Indicator only;
a MAC subheader with RAPID only (i.e. acknowledgment for SI request);
a MAC subheader with RAPID and MAC RAR.
   A MAC subheader with Backoff Indicator consists of five header fields E/T/R/R/BI as described in (FIG. 6 which is a reproduction of Figure 6.1.5-1 taken from 3GPP TS 38.321 v15.0.0). A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any).
   A MAC subheader with RAPID consists of three header fields E/T/RAPID as described in (FIG. 7 which is a reproduction of Figure 6.1.5-2 taken from 3GPP TS 38.321 v15.0.0).
   Padding is placed at the end of the MAC PDU if present. Presence and length of padding is implicit based on TB size, size of MAC subPDU(s).
   (FIG. 8 which is a reproduction of Figure 6.1.5-3 taken from 3GPP TS 38.321 v15.0.0)

### 6.2.2 MAC Subheader for Random Access Response

The MAC subheader consists of the following fields:
E: The Extension field is a flag indicating if the MAC subPDU including this MAC subheader is the last MAC subPDU or not in the MAC PDU. The E field is set to “1” to indicate at least another MAC subPDU follows. The E field is set to “0” to indicate that the MAC subPDU including this MAC subheader is the last MAC subPDU in the MAC PDU;
T: The Type field is a flag indicating whether the MAC subheader contains a Random Access Preamble ID or a Backoff Indicator. The T field is set to “0” to indicate the presence of a Backoff Indicator field in the subheader (BI). The T field is set to “1” to indicate the presence of a Random Access Preamble ID field in the subheader (RAPID);
R: Reserved bit, set to “0”;
BI: The Backoff Indicator field identifies the overload condition in the cell. The size of the BI field is 4 bits;
RAPID: The Random Access Preamble IDentifier field identifies the transmitted Random Access Preamble (see subclause 5.1.3). The size of the RAPID field is 6 bits. If the RAPID in the MAC subheader of a MAC subPDU corresponds to one of the Random Access Preambles configured for SI request, MAC RAR is not included in the MAC subPDU.
   The MAC subheader is octet aligned.

### 6.2.3 MAC Payload for Random Access Response

The MAC RAR is of fixed size as depicted in (FIG. 9 which is a reproduction of Figure 6.2.3-1 taken from 3GPP TS 38.321 v15.0.0), and consists of the following fields:
Timing Advance Command: The Timing Advance Command field indicates the index value T_{A} used to control the amount of timing adjustment that the MAC entity has to apply in TS 38.213 [6]. The size of the Timing Advance Command field is 12 bits;
UL Grant: The Uplink Grant field indicates the resources to be used on the uplink in TS 38.213 [6]. The size of the UL Grant field is 20 bits;
Temporary C-RNTI: The Temporary C-RNTI field indicates the temporary identity that is used by the MAC entity during Random Access. The size of the Temporary C-RNTI field is 16 bits.
   The MAC RAR is octet aligned.

3GPP TS 38.321 v15.0.0 introduces Beam Failure Recovery Request procedure as quoted below:

### 5.17 Beam Failure Recovery Request Procedure

The beam failure recovery request procedure is used for indicating to the serving gNB of a new SSB or CSI-RS when beam failure is detected on the serving SSB(s)/CSI-RS(s). Beam failure is detected by the lower layers and indicated to the MAC entity.

The MAC entity shall:
1> if beam failure indication has been received from lower layers:
   2> start beamFailureRecoveryTimer;
   2> initiate a Random Access procedure (see subclause 5.1) on the SpCell.
1> if the beamFailureRecoveryTimer expires:
   2> indicate beam failure recovery request failure to upper layers.
1> if downlink assignment or uplink grant on the PDCCH addressed for the C-RNTI has been received:
   2> stop and reset beamFailureRecoveryTimer;
   2> consider the Beam Failure Recovery Request procedure successfully completed.
      3GPP TS 38.331 v15.0.0 introduces RACH corresponding configuration as quoted below:
RACH-ConfigCommon
   The RACH-ConfigCommon IE is used to specify the cell specific random-access parameters.

### RACH-ConfigCommon Information Element

-- ASN1START
-- TAG-RACH-CONFIG-COMMON-START

| RACH-ConfigCommon ::= | | SEQUENCE { |
|---|---|---|
| | -- FFS: whether any of the parameter(s) in the L1 TP should be within CBRA-SSB-ResourceList | |
| | groupBconfigured | SEQUENCE { |

| -- FFS: ra-Msg3SizeGroupA values | |
|---|---|
| ra-Msg3SizeGroupA | ENUMERATED {b56, b144, b208, b256, b282, b480, b640, |

b800, b1000, spare7, spare6, spare5,

spare4, spare3, spare2, spare1},

| -- FFS: Need and definition of messagePowerOffsetGroupB | |
|---|---|
| messagePowerOffsetGroupB | ENUMERATED { minusinfinity, dB0, dB5, dB8, dB10, dB12, |

dB15, dB18}

| } OPTIONAL, | |
|---|---|
| cbra-SSB-ResourceList | CBRA-SSB-ResourceList, |
| ra-ContentionResolutionTimer | ENUMERATED { sf8, sf16, sf24, sf32, sf40, sf48, sf56, |

sf64},

-- Msg1 (RA preamble): -- UE may select the SS block and corresponding PRACH resource for

path-loss estimation and (re)transmission

| -- based on SS blocks that satisfy the threshold (see 38.213, section REF) | |
|---|---|
| ssb-Threshold | TYPE_FFS! |

OPTIONAL,

| -- FFS: Provide proper description | |
|---|---|
| -- Corresponds to L1 parameter ‘SUL-RSRP-Threshold’ (see FFS_Spec, section FFS_Section) | |
| sul-RSRP-Threshold | FFS_Value |

OPTIONAL,

-- PRACH configuration index. Corresponds to L1 parameter ‘PRACHConfigurationIndex’ (see

38.211, section 6.3.3.2)

| | |
|---|---|
| prach-ConfigurationIndex | INTEGER (0..255) |

OPTIONAL,

-- PRACH root sequence index. Corresponds to L1 parameter ‘PRACHRootSequenceIndex’ (see

38.211, section 6.3.3.1).

| -- The value range depends on whether L=839 or L=139 | |
|---|---|
| prach-RootSequenceIndex | CHOICE { |

| | |
|---|---|
| 1839 | INTEGER (0..837), |
| 1139 | INTEGER (0..137) |

}

OPTIONAL,

| -- N-CS configuration, see Table 6.3.3.1-3 in 38.211 | |
|---|---|
| zeroCorrelationZoneConfig | INTEGER(0..15), |

-- Configuration of restricted sets, see 38.211 6.3.3.1
-- CHECK: RAN1 value said “restrictedTypeA”. Does it mean “restrictedToTypeA”? If not, what

else?

| | |
|---|---|
| restrictedSetConfig | ENUMERATED {unrestricted, restrictedToTypeA, |

restrictedToTypeB},

| -- (see 38.213, section 7.4) | |
|---|---|
| preambleReceivedTargetPower | ENUMERATED { |

dBm-120, dBm-118, dBm-116, dBm-114, dBm-112, dBm-

110, dBm-108, dBm-106, dBm-104, dBm-102, dBm-100,

dBm-98, dBm-96, dBm-94,dBm-92, dBm-90, dBm-88,

dBm-86, dBm-84,dBm-82, dBm-80, dBm-78, dBm-76,

dBm-74, dBm-72, dBm-70, dBm-68, dBm-66, dBm-64,

dBm-62, dBm-60, dBm-58, dBm-56, dBm-54, dBm-52,

dBm-50, dBm-48, dBm-46, dBm-44, dBm-42, dBm-42, dBm-40, dBm-38, dBm-36, dBm-34, dBm-32, dBm-

| | |
|---|---|
| 30, | dBm-28, dBm-26, dBm-24, dBm-22, dBm- |

20, dBm-18, dBm-16, dBm-14, dBm-12, dBm-10, dBm-8, dBm-6,

| | |
|---|---|
| dBm-4, dBm-2, dBm-0, dBm2, dBm4, dBm6 } | OPTIONAL, |

| -- Power ramping steps for PRACH (see 38.321, FFS_section) | |
|---|---|
| powerRampingStep | ENUMERATED {dB0, dB2, dB4, dB6} |

OPTIONAL, -- Need R

-- CHECK: PreambleTransMax parameter usage (parameter was not provided by RANI and not yet

discussed in RAN2)

| | |
|---|---|
| PreambleTransMax ::= | ENUMERATED {n3, n4, n5, n6, n7, n8, n10, n20, n50, n100, |

n200}

| -- Msg2 (RAR) window length. Corresponds to L1 parameter ‘msg2-scs’ (see 38.213, section 8.1) | |
|---|---|
| ra-ResponseWindow | TYPE_FFS!, -- Subcarrier spacing for msg2 for |

contention-free RA procedure for handover.

| -- Corresponds to L1 parameter ‘msg2-scs’ (see 38.321?, section FFS_Section) | |
|---|---|
| msg2-SubcarrierSpacing | SubcarrierSpacing, |

-- CORESET configured for random access. When the field is absent the UE uses the CORESET

according to pdcchConfigSIB1

-- Corresponds to L1 parameter ‘rach-coreset-configuration’ (see 38.211?, section

FFS_Section)

| | | |
|---|---|---|
| rach-ControlResourceSet | FFS_Value | OPTIONAL, |

-- Subcarrier spacing for Msg3. Corresponds to L1 parameter ‘msg3-scs’ (see 38.213, section

8.1)

| msg3-SubcarrierSpacing | SubcarrierSpacing, |
|---|---|
| -- Indicates to a UE whether transform precoding is enabled for Msg3 transmission. | |
| -- Corresponds to L1 parameter ‘msg3-tp’ (see 38.213, section 8.1) | |
| msg3-transformPrecoding | ENUMERATED {true} |

OPTIONAL, -- Need R

}

| | |
|---|---|
| CBRA-SSB-ResourceList ::= | SEQUENCE (SIZE(1..maxRAssbResources)OF CSRA-SSB-Resource |
| CBRA-SSB-Resource ::= | SEQUENCE { |

| | |
|---|---|
| ssb | SSB-ID, |
| startIndexRA-PreambleGroupA | PreamblestartIndex, |
| numberofRA-PreamblesGroupA | NumberOfRA-Preambles, |
| numberOfRA-Preambles | NumberOfRA-Preambles, |

| -- PRACH configuration for SSB configuration (i.e. time and frequency location) | |
|---|---|
| -- FFS / TODO: Type Definition for RA-Resources. | |
| ra-Resources | RA-Resources |

}

| | |
|---|---|
| PreamblestartIndex | ::= INTEGER (0..maxRA-PreambleIndex) |
| NumberofRA-Preambles | ::= INTEGER (1.. maxNrOfRA-PreamblesPerSSB) |

-- TAG-RACH-CONFIG-COMMON-STOP
-- ASN1STOP

RACH-ConfigDedicated

The IE RACH-ConfigDedicated is used to specify the dedicated random access parameters.

### RACH-ConfigDedicated Information Element

-- ASN1START
-- TAG-RACH-CONFIG-DEDICATED-START
-- FFS: resources for msg1-based on-demand SI request
-- FFS: resources for beam failure recovery request

| | |
|---|---|
| RACH-ConfigDedicated ::= | SEQUENCE { |

| -- Resources for handover to the cell | |
|---|---|
| cfra-Resources | CFRA-Resources, |
| -- Subcarrier spacing for msg2 for contention-free RA procedure for handover | |
| rar-SubcarrierSpacing | SubcarrierSpacing |

}
-- FFS_CHECK: Isn't it sufficient to have just one list and the CHOICE inside the list element
(around the ssb/csirs)?

| | |
|---|---|
| CFRA-Resources ::= | CHOICE { |

| | |
|---|---|
| cfra-ssb-ResourceList | SEQUENCE (SIZE(1..maxRAssbResources) OF CFRA-SSB-Resource, |
| cfra-csirs-ResourceList | SEQUENCE (SIZE(1..maxRAcsirsResources)OF CFRA-CSIRS-Resource |

}

| | |
|---|---|
| CFRA-SSB-Resource ::= | SEQUENCE { |

| | |
|---|---|
| ssb | SSB-ID, |
| ra-PreambleIndex | INTEGER (0..FFS_XX), |

| -- PRACH configuration for SSB configuration (i.e. time and frequency location) | |
|---|---|
| ra-Resources | RA-Resources -- Definition FFS |

}

| | |
|---|---|
| CFRA-CSIRS-Resource ::= | SEQUENCE { |

| csirs | CSIRS-ID, -- FFS where the CSI-RS are defined (e.g. MO) |
|---|---|
| ra-PreambleIndex | INTEGER (0..FFS_XX), |
| -- PRACH configuration for CSIRS configuration (i.e. time and frequency location) | |
| ra-Resources | RA-Resources -- Definition FFS |

}
-- TAG-RACH-CONFIG-DEDICATED-STOP
-- ASN1STOP

3GPP TS 38.213 v15.0.0 introduces beam failure corresponding behaviors as quoted below:

### 6 Link Reconfiguration Procedures

A UE can be configured, for a serving cell, with a set q̅₀ of periodic CSI-RS resource configuration indexes by higher layer parameter Beam-Failure-Detection-RS-ResourceConfig and with a set q̅₁ of CSI-RS resource configuration indexes and/or SS/PBCH block indexes by higher layer parameter Candidate-Beam-RS-List for radio link quality measurements on the serving cell. If the UE is not provided with higher layer parameter Beam-Failure-Detection-RS-ResourceConfig, the UE determines q̅₀ to include SS/PBCH blocks and periodic CSI-RS configurations with same values for higher layer parameter TCI-StatesPDCCH as for control resource sets that the UE is configured for monitoring PDCCH as described in Subclause 10.1.
The physical layer in the UE shall assess the radio link quality according to the set q̅₀ of resource configurations against the threshold Q_{out,LR} [10, TS 38.133]. The threshold Q_{out,LR} corresponds to the default value of higher layer parameter RLM-IS-OOS-thresholdConfig and Beam-failure-candidate-beam-threshold, respectively. For the set q̅₀, the UE shall assess the radio link quality only according to periodic CSI-RS resource configurations or SS/PBCH blocks that are quasi co-located, as described in [6, TS 38.214], with the DM-RS of PDCCH receptions DM-RS monitored by the UE. The UE applies the configured Q_{in,LR} threshold for the periodic CSI-RS resource configurations. The UE applies the Q_{out,LR} threshold for SS/PBCH blocks after scaling a SS/PBCH block transmission power with a value provided by higher layer parameter Pc_SS.
The physical layer in the UE shall, in slots where the radio link quality according to the set q̅₀ is assessed, provide an indication to higher layers when the radio link quality for all corresponding resource configurations in the set q̅₀ that the UE uses to assess the radio link quality is worse than the threshold Q_{out,LR}.
The UE shall provide to higher layers information identifying a periodic CSI-RS configuration index or SS/PBCH block index q_{new} from the set q̅₁.
A UE is configured with one control resource set by higher layer parameter Beam-failure-Recovery-Response-CORESET. The UE may receive from higher layers, by parameter Beam-failure-recovery-request-RACH-Resource, a configuration for a PRACH transmission as described in Subclause 8.1. After 4 slots from the slot of the PRACH transmission, the UE monitors PDCCH for a DCI format with CRC scrambled by C-RNTI, within a window configured by higher layer parameter Beam-failure-recovery-request-window, and receives PDSCH according to an antenna port quasi co-location associated with periodic CSI-RS configuration or SS/PBCH block with index q_{new} in set q̅₁, in the control resource set configured by higher layer parameter Beam-failure-Recovery-Response-CORESET.

The following terminology may be used hereafter in the detailed description:
BS: a network central unit or a network node in NR which is used to control one or multiple transmission and reception points (TRPs) which are associated with one or multiple cells. Communication between BS and TRP(s) is via fronthaul. The BS could also be referred to as central unit (CU), evolved Node B (eNB), next generation Node B (gNB), or NodeB.
TRP: a transmission and reception point provides network coverage and directly communicates with UEs. TRP could also be referred to as distributed unit (DU) or network node.
Cell: a cell is composed of one or multiple associated TRPs, i.e. coverage of the cell is composed of coverage of all associated TRP(s). One cell is controlled by one BS. A cell could also be referred to as a TRP group (TRPG).
Serving beam: serving beam for a UE is a beam generated by a network node, e.g. TRP, which is currently used to communicate with the UE, e.g. for transmission and/or reception.
Candidate beam: candidate beam for a UE is a candidate of a serving beam. Serving beam may or may not be candidate beam.
PDCCH: A channel carries downlink control signal which is used to control communication between a UE and a network side. A network transmits NR-PDCCH on configured control resource set (CORESET) to the UE.

For the network side, the following terminology may used herein after in the detailed description:
NR using beamforming could be standalone, i.e. UE can directly camp on or connect to NR.
   NR using beamforming and NR not using beamforming could coexist, e.g. in different cells.
TRP would apply beamforming to both data and control signaling transmissions and receptions, if possible and beneficial.
   Number of beams generated concurrently by TRP depends on TRP capability, e.g. maximum number of beams generated concurrently by different TRPs may be different.
   Beam sweeping is necessary, e.g. for the control signaling to be provided in every direction.
   (For hybrid beamforming) TRP may not support all beam combinations, e.g. some beams could not be generated concurrently. FIG. 9 shows an example for combination limitation of beam generation.
Downlink timing of TRPs in the same cell are synchronized.
RRC layer of network side is in BS.
TRP should support both UEs with UE beamforming and UEs without UE beamforming, e.g. due to different UE capabilities or UE releases.

For the UE side, the following terminology may be used herein after in the detailed description:
UE may perform beamforming for reception and/or transmission, if possible and beneficial.
   Number of beams generated concurrently by UE depends on UE capability, e.g. generating more than one beam is possible.
   Beam(s) generated by UE is wider than beam(s) generated by TRP, gNB, or eNB.
   Beam sweeping for transmission and/or reception is generally not necessary for user data but may be necessary for other signaling, e.g. to perform measurement.
   (For hybrid beamforming) UE may not support all beam combinations, e.g. some beams could not be generated concurrently. FIG. 9 shows an example for combination limitation of beam generation.
Not every UE supports UE beamforming, e.g. due to UE capability or UE beamforming is not supported in NR first (few) release(s).
One UE is possible to generate multiple UE beams concurrently and to be served by multiple serving beams from one or multiple TRPs of the same cell.
   Same or different (DL or UL) data could be transmitted on the same radio resource via different beams for diversity or throughput gain.

The Beam failure recovery request procedure is introduced for indicating to a serving gNB of a new Synchronized Signal (SS) block (SSB) or Channel State Information based Reference Signal (CSI-RS) when a beam failure is detected on the serving SSB(s)/CSI-RS(s). Beam failure may be detected by the lower layers (e.g., Physical (PHY) layer) and indicated to the Medium Access Control (MAC) entity. Beam failure may be detected by counting beam failure instance indication from the lower layers to the MAC entity.

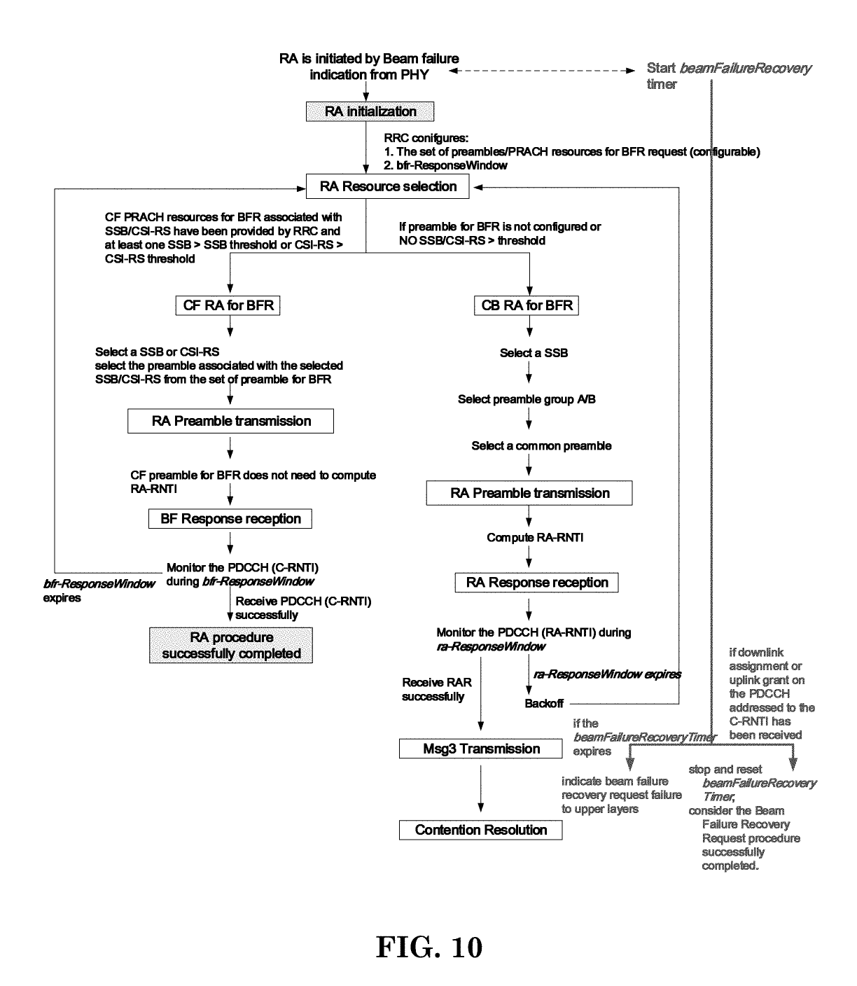

As an illustration shown in FIG. 10, a random access procedure could be initiated based on a beam failure indication from a lower layer. When the beam failure indication has been received from the lower layers and/or a beam failure indication counter reaches to a maximum time (e.g., BFI_COUNTER>=beamFailureInstanceMaxCount+1), the MAC entity may start a beam failure recovery timer (e.g., initiate a beam failure recovery request procedure) and may initiate a random access procedure for beam failure recovery. During the random access procedure for beam failure recovery, if the contention-free (CF) Physical Random Access Channel (PRACH) resources for beam failure recovery request associated with any of the SSBs and/or CSI-RS have been explicitly provided by the Radio Resource Control (RRC) and at least one of the SS blocks with a Synchronization Signal-Reference Signal Received Power (SS-RSRP) above a SSB threshold (e.g., rsrp-ThresholdSSB) amongst the associated SS blocks or the CSI-RSs with CSI-RSRP above a CSI-RS threshold (e.g., csirs-dedicatedRACH-Threshold) amongst the associated CSI-RSs is available, the UE could perform a CF random access procedure for beam failure recovery. Otherwise, the UE may perform a contention-based (CB) random access procedure for beam failure recovery.

For a Contention-Free (CF) random access procedure, after the UE transmits a RA preamble, the UE may monitor a beam failure response during a beam failure response window (e.g., bfr-ResponseWindow) or a random access response window (e.g., ra-Response Window). The beam failure response may be a PDCCH which is addressed to a Cell Radio Network Temporary Identifier (C-RNTI). If the UE receives a downlink assignment or an uplink grant on the PDCCH addressed to the C-RNTI (and/or the beam failure recovery timer is not expired), the UE may consider the beam failure recovery request procedure successfully completed and also consider the random access procedure successfully completed. The UE may then stop and/or reset the beam failure recovery timer. On the other hand, if the beam failure recovery timer is expired, the UE may indicate a beam failure recovery request failure to the upper layers.

For a CB random access procedure, the difference is that after the UE transmits a Random Access (RA) preamble, the UE may monitor a random access response (RAR) during a RAR window (e.g., ra-Response Window). The RAR may be a PDCCH which is addressed to a Random Access Radio Network Temporary Identifier (RA-RNTI). If the UE receives the RAR successfully, the UE may not consider the beam failure recovery request procedure successfully completed since the PDCCH is not addressed to C-RNTI. Also, the UE may not consider the random access procedure successfully completed since the contention resolution for the CB random access procedure is not completed. Therefore, the UE may transmit Msg3 and then receive Msg4 for contention resolution to complete the random access procedure. If the UE could receive the Msg4 which is a PDCCH addressed to the C-RNTI successfully, the UE may consider the random access procedure successfully completed and consider the beam failure recovery request procedure successfully completed.

However, if the UE receives a PDCCH addressed to the C-RNTI (and the beam failure recovery timer has not expired) before receiving Msg4 of the random access procedure, the UE may consider the beam failure recovery request procedure successfully completed but may not consider the random access procedure successfully completed since the contention resolution has not been finished. Then the UE may still perform the random access procedure for beam failure recovery even though the beam failure recovery request procedure has been considered successful. Since the purpose of beam failure recovery is reached, performing the unnecessary random access procedure would cause undue power consumption, which should be avoided.

Additionally, if the UE receives a downlink assignment (e.g., rather than an uplink grant) on a PDCCH addressed to the C-RNTI, the UE may consider the beam failure recovery request procedure successfully completed. However, based on the behavior of the MAC spec as disclose in 3GPP TS 38.321 v15.0.0, the UE may not consider the random access procedure successfully completed if the random access procedure is initiated by the MAC sublayer itself. Accordingly, the UE may still perform an unnecessary random access procedure for beam failure recovery even though the beam failure recovery request procedure has been considered successfully completed.

Thus, several alternatives are depicted below to avoid the scenario where the completion of the beam failure recovery request procedure and the completion of the random access procedure are not aligned.

According to one alternative, the completion of the random access procedure is based on the completion of the beam failure recovery request procedure. When a beam failure indication has been received from lower layers (e.g., Physical (PHY) layer) and/or a beam failure indication counter reaches to a maximum time (e.g., BFI_COUNTER>=beamFailureInstanceMaxCount+1), the UE may start a beam failure recovery timer (e.g., initiate a beam failure recovery request procedure) and may initiate a random access procedure. Then, if the UE receives a PDCCH addressed to the C-RNTI (e.g. a downlink assignment or uplink grant on the PDCCH addressed to the C-RNTI) before transmitting Msg3, the UE may not stop and/or reset the beam failure recovery timer. Also, the UE may not consider the beam failure recovery request procedure successfully completed. Preferably, the UE may or may not indicate the beam failure recovery request failure to upper layers if the beam failure recovery timer expires.

For example, if the UE receives a PDCCH addressed to the C-RNTI after starting the beam failure recovery request timer and the beam failure recovery timer is not expired, the UE may consider the random access procedure successfully completed and consider the beam failure recovery request procedure successfully completed. Alternatively, if the UE receives a PDCCH addressed to the C-RNTI at any step during the random access procedure, the UE may consider the random access procedure successfully completed and consider the beam failure recovery request procedure successfully completed.

In another example, if the UE receives a PDCCH addressed to the C-RNTI, wherein the PDCCH is not Msg4 (or not for contention resolution) during the random access procedure, the UE may consider the random access procedure successfully completed and consider the beam failure recovery request procedure successfully completed. In one example, the PDCCH is received before receiving the Msg4.

In another example, if the UE receives a PDCCH addressed to the C-RNTI, wherein the PDCCH is not a response (e.g., a response for the beam failure recovery request) to the random access procedure, the UE may consider the random access procedure successfully completed and consider the beam failure recovery request procedure successfully completed.

In another example, if the UE receives a PDCCH addressed to the C-RNTI, wherein the PDCCH is not monitored during the beam failure response window, the UE may consider the random access procedure successfully completed and consider the beam failure recovery request procedure successfully completed.

In another example, if the UE receives a PDCCH addressed to the C-RNTI, wherein the PDCCH is monitored during the random access response window, the UE may consider the random access procedure successfully completed and consider the beam failure recovery request procedure successfully completed.

In another example, if the UE receives a PDCCH addressed to the C-RNTI, wherein the PDCCH is not monitored during the random access response window, the UE may consider the random access procedure successfully completed and consider the beam failure recovery request procedure successfully completed.

In another alternative, the completion of the beam failure recovery request procedure is based on the completion of the random access procedure. When a beam failure indication has been received from lower layers (e.g., PHY layer) and/or a beam failure indication counter reaches to a maximum time (e.g., BFI_COUNTER>=beamFailureInstanceMaxCount+1), the UE may start a beam failure recovery timer (e.g., initiate a beam failure recovery request procedure) and may initiate a random access procedure. Then, if the UE receives a PDCCH addressed to the C-RNTI (e.g., a downlink assignment or uplink grant on the PDCCH addressed to the C-RNTI) before transmitting Msg3, the UE may not stop and/or reset the beam failure recovery timer. The UE may not consider the beam failure recovery request procedure successfully completed. Alternatively, the UE may or may not indicate the beam failure recovery request failure to upper layers if the beam failure recovery timer expires.

In one example, the UE may not consider the beam failure recovery request procedure successfully completed before considering the contention resolution successful. In another example, the UE may not consider the beam failure recovery request procedure successfully completed before transmitting Msg3 or receiving Msg4.

In one example, the UE may consider the beam failure recovery request procedure successfully completed when the UE considers the contention resolution successful. In another example, the UE may consider the beam failure recovery request procedure successfully completed when the UE considers the random access procedure successfully completed.

In one example, the UE may consider the beam failure recovery request procedure successful if (a) notification of a reception of a PDCCH transmission is received from lower layers, (b) if the C-RNTI MAC CE was included in Msg3, if the random access procedure was initiated by the MAC sublayer or by lower layers, and (c) the PDCCH transmission is addressed to the C-RNTI. Otherwise, the UE may not consider the beam failure recovery request procedure successfully completed.

In one example, the UE may consider the beam failure recovery request procedure successful if (a) notification of a reception of a PDCCH transmission is received from lower layers, (b) the C-RNTI MAC CE was included in Msg3, (c) the random access procedure was initiated by the beam failure indication, and (d) the PDCCH transmission is addressed to the C-RNTI. Otherwise, the UE may not consider the beam failure recovery request procedure successfully completed.

In one exemplary method, the random access procedure may be contention-based random access procedure or contention-free random access procedure. The random access procedure may be initiated by a beam failure indication from the lower layers and/or a beam failure indication counter reaches to a maximum time (e.g., BFI_COUNTER>=beamFailureInstanceMaxCount+1). For a contention-based random access procedure, the UE may select a common RA preamble, wherein the common RA preamble may be shared by different UEs. In another embodiment, for a contention-free random access procedure, the UE may select a RA preamble which is associated with the set of RA preambles for a beam failure recovery request and a corresponding PRACH resource(s). In one embodiment, the set of RA preambles for beam failure recovery request may be configured by a RRC.

In one exemplary method, when the UE start a beam failure recovery timer, the UE may initiate a beam failure recovery request procedure.

In one exemplary method, the UE may indicate a beam failure recovery request failure to upper layers when the UE indicate a random access problem to the upper layers. In one method, the UE may indicate a beam failure recovery request failure to upper layers if PREAMBLE_TRANSMISSION_COUNTER=preambleTransMax+1.

In one exemplary method, when a beam failure indication has been received from the lower layers and/or a beam failure indication counter reaches to a maximum time (e.g., BFI_COUNTER>=beamFailureInstanceMaxCount+1), the UE may start a beam failure recovery timer and may initiate a random access procedure. Then, if the UE receives a PDCCH addressed to the C-RNTI during a beam failure response window, the UE may consider the random access procedure successfully completed and/or consider the beam failure recovery request procedure successfully completed. Alternatively, if the UE receives a PDCCH addressed to the C-RNTI during the random access response window, the UE may consider the random access procedure successfully completed and/or may consider the beam failure recovery request procedure successfully.

In one exemplary method, if the UE receives a PDCCH addressed to the C-RNTI not during the beam failure response window, the UE may not consider the random access procedure successfully completed and/or may not consider the beam failure recovery request procedure successfully. Alternatively, if the UE receives a PDCCH addressed to the C-RNTI during the random access procedure but not during the beam failure response window, the UE may not consider the random access procedure successfully completed and/or may not consider the beam failure recovery request procedure successfully.

In one exemplary method, the PDCCH may be addressed to the C-RNTI or RA-RNTI. The PDCCH may include a downlink assignment. The PDCCH may include an UL grant. The PDCCH may or may not be transmitted via a candidate beam. The PDCCH may include a downlink control information (DCI). The PDCCH may indicate a Physical Downlink Shared Channel (PDSCH). The PDCCH may indicate a Physical Uplink Control Channel (PUSCH).

In one or more of the above exemplary methods, beam failure means that the radio link qualify of the serving beam (e.g., SSB and/or CSI-RS) may be worse than a threshold value.

In one or more of the above exemplary methods, the SSB may be associated with a DL beam of the network.

In one or more of the above exemplary methods, the CSI-RS may be associated with a DL beam of the network.

In one or more of the above exemplary methods, the higher layer may be the RRC layer.

In one or more of the above exemplary methods, the lower layer may be the PHY layer.

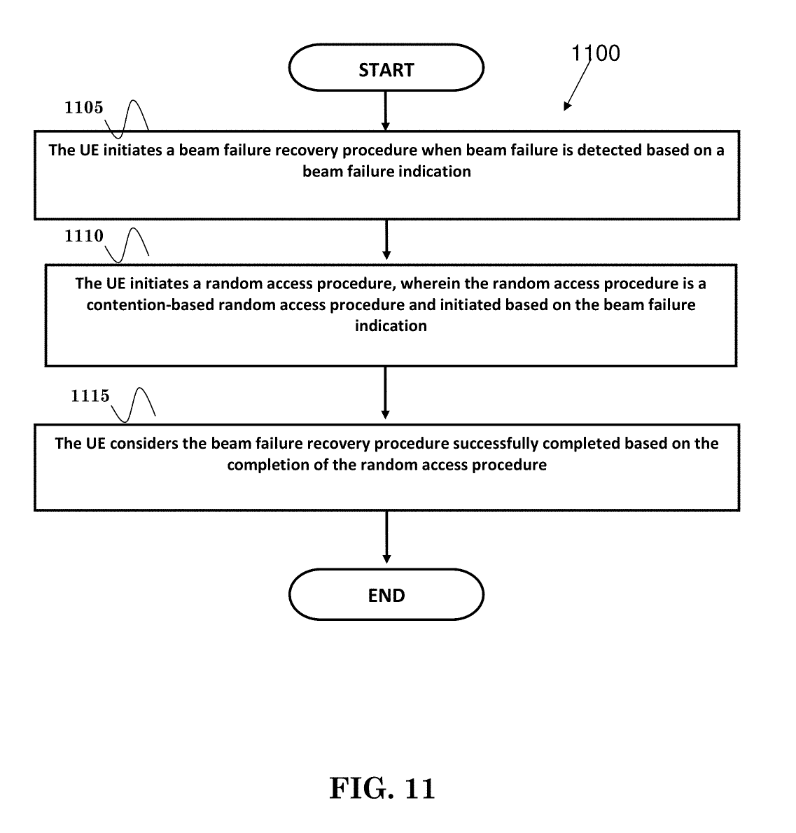

FIG. 11 is a flow chart 1100 according to one exemplary embodiment from the perspective of a UE. In step 1105, the UE initiates a beam failure recovery procedure when beam failure is detected based on a beam failure indication. In step 1110, the UE initiates a random access procedure, wherein the random access procedure is a contention-based random access procedure and initiated based on the beam failure indication. In step 1115, the UE considers the beam failure recovery procedure successfully completed based on completion of the random access procedure.

In another method, the UE does not consider the beam failure recovery procedure successfully completed when receiving a signal from a network node before transmitting a Msg3 of the random access procedure, wherein the signal is a Physical Downlink Control Channel (PDCCH) addressed to a Cell Radio Network Temporary Identifier (C-RNTI).

In another method, the UE indicates a beam failure recovery request failure to an upper layer if PREAMBLE_TRANSMISSION_COUNTER=preambleTransMax+1.

In another method, the UE stops a beam failure recovery timer when considering the beam failure recovery request procedure successfully completed.

In another method, the beam failure recovery timer is started or restarted when a beam failure indication is received from a Physical layer.

In another method, the UE does not consider the beam failure recovery procedure successfully completed if the random access procedure is not considered successfully completed.

In another method, the UE does not consider the beam failure recovery request procedure successfully completed before considering a contention resolution of the random access procedure successful.

In another method, the random access procedure is initiated by Medium Access Control (MAC) layer.

In another method, the beam failure indication is indicated from a Physical layer to a Medium Access Control layer.

In another exemplary method, the UE initiates a random access procedure, wherein the random access procedure is a contention-based random access procedure and initiated based on a beam failure indication; the UE starts a beam failure recovery timer, wherein starting the beam failure recovery timer may mean that a beam failure recovery request procedure is initiated; the UE receives a signal from a network node, wherein the signal may be a PDCCH addressed to a C-RNTI; the UE considering the beam failure recovery request procedure successfully completed; and the UE considers the contention-based random access procedure successfully completed.

In one or more of the above-disclosed methods, the beam failure recovery timer is not expired.

In one or more of the above-disclosed methods, the signal is not Msg4 of the random access procedure.

In one or more of the above-disclosed methods, the signal is not for a contention resolution of the random access procedure.

In one or more of the above-disclosed methods, the signal may be received before receiving Msg4 of the random access procedure.

In one or more of the above-disclosed methods, the signal may be received before transmitting Msg3 of the random access procedure.

In one or more of the above-disclosed methods, the signal is not a response for the beam failure recovery request.

In one or more of the above-disclosed methods, the signal is not a response to the random access procedure.

In one or more of the above-disclosed methods, the signal may be or may not be received during a beam failure response window, wherein the beam failure response window is a time window to monitor response(s).

In one or more of the above-disclosed methods, the signal may be or may not be received during a random access response window, wherein the random access response window is a time window to monitor RA response(s).

In one or more of the above-disclosed methods, the UE may stop the random access procedure when receiving the signal.

In another exemplary method, the UE initiates a random access procedure, wherein the random access procedure is a contention-based random access procedure and initiated based on a beam failure indication; and the UE considers the beam failure recovery request procedure successfully completed when the random access procedure is considered successfully completed.

In another exemplary method, the UE initiates a random access procedure, wherein the random access procedure is a contention-based random access procedure and initiated by a beam failure indication; the UE starts a beam failure recovery timer, wherein starting the beam failure recovery timer may mean that a beam failure recovery request procedure is initiated; the UE receives a signal from a network node before transmitting a Msg3 of the random access procedure, wherein the signal may be a PDCCH addressed to a C-RNTI; and the UE does not consider the beam failure recovery request procedure successfully completed.

In one or more of the above-disclosed methods, if the random access procedure is not considered successfully completed, the UE could not consider the beam failure recovery request procedure successfully completed.

In one or more of the above-disclosed methods, the UE may or may not indicate a beam failure recovery request failure to an upper layer.

In one or more of the above-disclosed methods, the UE may not consider the beam failure recovery request procedure successfully completed before considering a contention resolution of the random access procedure successful.

In one or more of the above-disclosed methods, the UE may consider the beam failure recovery request procedure successfully completed when the UE considers the contention resolution successful.

In one or more of the above-disclosed methods, the UE may consider the beam failure recovery request procedure successfully completed when the UE considers the random access procedure successfully completed.

In another exemplary method, the UE initiates a random access procedure, wherein the random access procedure is a contention-free random access procedure and initiated based on a beam failure indication and/or a beam failure indication counter reaches to a maximum time (e.g., BFI_COUNTER>=beamFailureInstanceMaxCount+1); the UE starts a beam failure recovery timer, wherein starting the beam failure recovery timer may mean that a beam failure recovery request procedure is initiated; the UE receives a signal from a network, wherein the signal may be a PDCCH addressed to a C-RNTI and not received during a beam failure response window; the UE does not consider the random access procedure successfully completed; and the UE does not consider the beam failure recovery request procedure successfully completed.

In one or more of the above-disclosed methods, the signal is not a Msg4 of the random access procedure.

In one or more of the above-disclosed methods, the signal is not for contention resolution of the random access procedure.

In one or more of the above-disclosed methods, the signal may be received before receiving a Msg4 of the random access procedure.

In one or more of the above-disclosed methods, the signal may be received before transmitting a Msg3 of the random access procedure.

In one or more of the above-disclosed methods, the signal is not a response for the beam failure recovery request of the beam failure recovery procedure.

In one or more of the above-disclosed methods, the signal is not a response to the random access procedure.

In one or more of the above-disclosed methods, the signal may be or may not be received during a beam failure response window, wherein the beam failure response window is a time window to monitor response(s).

In one or more of the above-disclosed methods, the signal may be or may not be received during a random access response window, wherein the random access response window is a time window to monitor RA response(s).

In one or more of the above-disclosed methods, the UE may stop the random access procedure when receiving the signal.

In one or more of the above-disclosed methods, the UE may indicate a beam failure recovery request failure to upper layers when the UE indicates a random access problem to an upper layer.

In one or more of the above-disclosed methods, the UE may indicate a beam failure recovery request failure to an upper layer when the UE indicates a random access problem to an upper layer.

In one or more of the above-disclosed methods, the UE may indicate a beam failure recovery request failure to an upper layer if PREAMBLE_TRANSMISSION_COUNTER=preambleTransMax+1.

In one or more of the above-disclosed methods, the UE may stop the beam failure recovery timer when considering the beam failure recovery request procedure successfully completed.

In one or more of the above-disclosed methods, the UE may reset the beam failure recovery timer when considering the beam failure recovery request procedure successfully completed.

In one or more of the above-disclosed methods, the random access procedure may be a contention-based random access procedure.

In one or more of the above-disclosed methods, the random access procedure may be a contention-free random access procedure.

In one or more of the above-disclosed methods, the random access procedure may be initiated based on a beam failure indication.

In one or more of the above-disclosed methods, the random access procedure may be initiated by a PHY layer.

In one or more of the above-disclosed methods, the random access procedure may be initiated by a MAC layer.

In one or more of the above-disclosed methods, the random access procedure may be initiated by a RRC layer.

In one or more of the above-disclosed methods, the signal may indicate a downlink assignment.

In one or more of the above-disclosed methods, the signal may indicate an uplink grant.

In one or more of the above-disclosed methods, the upper layer may be a RRC layer.

In one or more of the above-disclosed methods, the lower layer may be a PHY layer.

In one or more of the above-disclosed methods, the beam failure indication may be indicated from a PHY layer to a MAC layer.

Referring back to FIGS. 3 and 4, in one embodiment, the device 300 includes a program code 312 stored in memory 310. The CPU 308 could execute program code 312 to enable the network (i) to initiate a beam failure recovery procedure when beam failure is detected based on a beam failure indication; (ii) to initiate a random access procedure, wherein the random access procedure is a contention-based random access procedure and initiated based on the beam failure indication; and (iii) to consider the beam failure recovery procedure successfully completed based on completion of the random access procedure.

Furthermore, the CPU 308 can execute the program code 312 to perform all of the above-described actions and steps or others methods described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a user equipment (UE), the method comprising:
initiating a beam failure recovery procedure when beam failure is detected based on a beam failure indication;
initiating a random access procedure, wherein the random access procedure is a contention-based random access procedure and initiated based on the beam failure indication; and
considering the beam failure recovery procedure successfully completed based on completion of the random access procedure.

2. The method of claim 1, further comprising:
not considering the beam failure recovery procedure successfully completed when receiving a signal from a network node before transmitting a Msg3 of the random access procedure, wherein the signal is a Physical Downlink Control Channel (PDCCH) addressed to a Cell Radio Network Temporary Identifier (C-RNTI).

3. The method of claim 2, wherein the signal is not a response for the beam failure recovery request of the beam failure recovery procedure.

4. The method of claim 1, further comprising:
indicating a beam failure recovery request failure to an upper layer if PREAMBLE_TRANSMISSION_COUNTER=preambleTransMax+1.

5. The method of claim 1, further comprising:
stopping a beam failure recovery timer when considering the beam failure recovery request procedure successfully completed.

6. The method of claim 5, wherein the beam failure recovery timer is started or restarted when a beam failure indication is received from a Physical layer.

7. The method of claim 1, further comprising:
not considering the beam failure recovery procedure successfully completed if the random access procedure is not considered successfully completed.

8. The method of claim 1, further comprising:
not considering the beam failure recovery request procedure successfully completed before considering a contention resolution of the random access procedure successful.

9. The method of claim 1, wherein the random access procedure is initiated by Medium Access Control (MAC) layer.

10. The method of claim 1, wherein the beam failure indication is indicated from a Physical layer to a Medium Access Control layer.

11. A user equipment (UE), comprising:
a control circuit;
a processor installed in the control circuit;
a memory installed in the control circuit and coupled to the processor;
wherein the processor is configured to execute a program code stored in the memory to:
initiate a beam failure recovery procedure when beam failure is detected based on a beam failure indication;
initiate a random access procedure, wherein the random access procedure is a contention-based random access procedure and initiated based on the beam failure indication; and
consider the beam failure recovery procedure successfully completed based on completion of the random access procedure.

12. The UE of claim 11, wherein the processor is further configured to:
not consider the beam failure recovery procedure successfully completed when receiving a signal from a network node before transmitting a Msg3 of the random access procedure, wherein the signal is a Physical Downlink Control Channel (PDCCH) addressed to a Cell Radio Network Temporary Identifier (C-RNTI).

13. The UE of claim 12, wherein the signal is not a response for the beam failure recovery request of the beam failure recovery procedure.

14. The UE of claim 11, wherein the processor is further configured to:
indicate a beam failure recovery request failure to an upper layer if PREAMBLE_TRANSMISSION_COUNTER=preambleTransMax+1.

15. The UE of claim 11, wherein the processor is further configured to:
stop a beam failure recovery timer when considering the beam failure recovery request procedure successfully completed.

16. The UE of claim 15, wherein the beam failure recovery timer is started or restarted when a beam failure indication is received from a Physical layer.

17. The UE of claim 11, wherein the processor is further configured to:
not consider the beam failure recovery procedure successfully completed if the random access procedure is not considered successfully completed.

18. The UE of claim 11, wherein the processor is further configured to:
not consider the beam failure recovery request procedure successfully completed before considering a contention resolution of the random access procedure successful.

19. The UE of claim 11, wherein the the random access procedure is initiated by Medium Access Control (MAC) layer.

20. The UE of claim 11, wherein the beam failure indication is indicated from a Physical layer to a Medium Access Control layer.
